(19) United States
(12) Patent Application Publication
(10) Pub. No.: US 2005/0066223 A1
(43) Pub. Date: Mar. 24, 2005

(54) Access control method and module with data recovery option for a hard disk

(75) Inventor: Yuan-Lung Chang, Taipei City (TW)

Correspondence Address: OSTROLENK FABER GERB & SOFFEN, 1180 AVENUE OF THE AMERICAS, NEW YORK, NY, 100368403, US

(73) Assignee: eTrunk Technologies Inc.

(21) Appl. No.: 10/748,787

(22) Filed: Dec. 29, 2003

(30) Foreign Application Priority Data
Sep. 19, 2003 (TW) 092125969

(51) Int. Cl. G06F 11/00

(52) U.S. Cl. 714/5

(57) ABSTRACT

An access control method for a hard disk includes the steps of partitioning the hard disk into primary and secondary partitions, creating a recovery file and storing the recovery file in the secondary partition upon receipt of a write command from a host terminal, and retrieving the recovery files from the secondary partition and restoring the primary partition based on the contents of the retrieved recovery files upon receipt of a recover command from a host terminal. A module that performs the method is also disclosed.

### CROSS-REFERENCE TO RELATED APPLICATION

This application claims priority of Taiwanese Application No. 092125969, filed on Sep. 19, 2003.

### BACKGROUND OF THE INVENTION

1. Field of the Invention

The invention relates to an access control method and module for a hard disk, more particularly to an access control method and module with data recovery option for a hard disk.

2. Description of the Related Art

A conventional recovery software utility for a hard disk, such as the Symantec's Norton Ghost, makes a backup by creating an image file of the whole hard disk. The created image file can then be used to restore the hard disk, after a major disaster such as a disk drive crash or a computer virus infection, to a state when the image file was created.

Although the conventional recovery software utility achieves its intended purpose, the backup procedure is manually performed, creates a relatively large backup file, and takes a relatively long time to complete. The conventional recovery software utility is therefore not suitable for a real-time back-up application. As such, the hard disk may not be restored to its latest workable state.

### SUMMARY OF THE INVENTION

Therefore, the object of the present invention is to provide an access control method and module that automatically creates a backup of a hard disk so as to overcome the aforementioned drawbacks of the prior art.

According to one aspect of the present invention, an access control method for a hard disk comprises the steps of:
(A) partitioning the hard disk into primary and secondary partitions;
(B) in response to a write command from a host terminal for storing write data in an addressable space found in the primary partition of the hard disk,
   (i) creating a recovery file that includes a write time, an address of the addressable space, and recover information including a starting data found in the addressable space of the hard disk during the write time, and
   (ii) storing the write data in the primary partition at the address of the addressable space, and the recovery file in the secondary partition; and
(C) in response to a recover command from the host terminal,
   (a) retrieving the recovery files from the secondary partition, the write time in each of the retrieved recovery files being not earlier than a recovery time associated with the recover command, and
   (b) based on the contents of the recovery files retrieved in sub-step (a), restoring the primary partition to the starting data initially found therein during the recovery time.

According to another aspect of the present invention, there is provided an access control module for a hard disk that is partitioned into primary and secondary partitions. The access control module is responsive to write and recover commands from a host terminal, and comprises a processor, a first interface, a second interface, a command interpreter, and a recovery file creator. The first interface is adapted to connect the processor to the host terminal. The second interface is adapted to connect the processor to the hard disk. The command interpreter is coupled to the first interface for interpreting the write and recover commands. The recovery file creator is coupled to the processor and the command interpreter. In response to the write command for storing write data in an addressable space found in the primary partition of the hard disk, the command interpreter enables the recovery file creator to create a recovery file. The recovery file includes a write time, an address of the addressable space, and recover information. The recover information includes a starting data found in the addressable space of the hard disk during the write time. The command interpreter further enables the processor to store the write data in the primary partition at the address of the addressable space, and the recovery file in the secondary partition. In response to a recover command from the host terminal, the command interpreter enables the processor to retrieve the recovery files from the secondary partition. The write time in each of the retrieved recovery files is not earlier than a recovery time associated with the recover command. Furthermore, based on the contents of the recovery files retrieved by the processor, the command interpreter enables the processor to restore the primary partition to the starting data initially found therein during the recovery time.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of the preferred embodiment of an access control module for a hard disk according to the present invention;

FIG. 2 is a schematic view illustrating the hard disk partitioned into primary and secondary partitions in accordance with the preferred embodiment; and

FIG. 3 is a flow chart of the preferred embodiment of a method for restoring the primary partition of the hard disk to a previous state according to the present invention.

### DETAILED DESCRIPTION OF THE PREFERRED EMBODIMENT

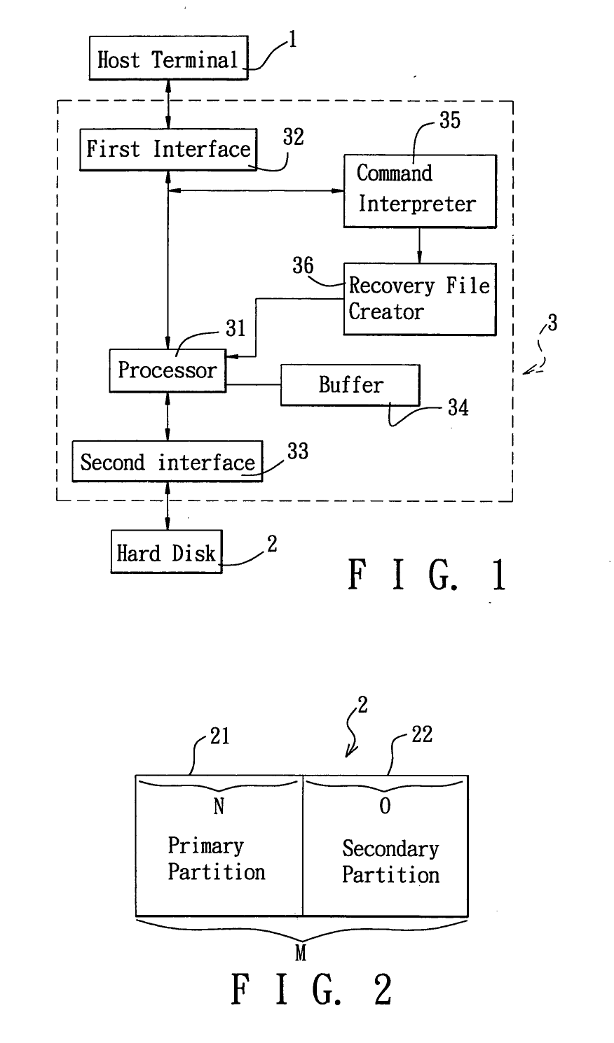

Referring to FIGS. 1 and 2, the preferred embodiment of an access control module 3 for a hard disk 2 according to this invention is shown to include a processor 31, a first interface 32, a second interface 33, a command interpreter 35, and a recovery file creator 36.

In this embodiment, the access control module 3 is in the form of a computer chip and is implemented in a host terminal 1, such as a personal computer. In an alternative embodiment, the access control module 3 is implemented in a server (not shown) on a server-client network (not shown).

The hard disk 2, which has a total storage capacity (M), is partitioned into primary and secondary partitions 21, 22. Accordingly, the primary partition 21 has a storage capacity (N) that is less than the total storage capacity (M), while the secondary partition 22 has a storage capacity (O) that is equal to the difference between the total storage capacity (M) and the storage capacity (N).

The host terminal 1 includes a central processing unit (not shown) and the hard disk 2. The central processing unit generates a write command for storing write data in an addressable space found in the primary partition 21 of the hard disk 2, and a recover command.

The access control module 3 further includes a buffer 34 connected to the processor 31, and is responsive to the write and recover commands from the central processing unit of the host terminal 1, in a manner to be described hereinafter.

The first interface 32 is adapted to connect the processor 31 to the central processing unit of the host terminal 1. The second interface 33 is adapted to connect the processor 31 to the hard disk 2. Preferably, each of the first and second interfaces 32, 33 is an IDE or SCSI interface. The command interpreter 35 is connected to the first interface 32 for interpreting the write and recover commands. The recovery file creator 36 is connected to the processor 31 and the command interpreter 35.

In response to the write command from the central processing unit of the host terminal 1, the command interpreter 35 enables the recovery file creator 36 to create a recovery file. The recovery file includes a write time (i.e., the time the write command is received through the first interface 32), an address of the addressable space, and recover information. The recover information includes a starting data found in the addressable space of the hard disk 2 during the write time, and the write data. Preferably, prior to storage in the hard disk 2, the processor 31 stores the address of the addressable space, the write data and the recovery file in the buffer 34. Once the processor 31 enters an idle state, the processor 31 is enabled by the command interpreter 35 to store the write data in the primary partition 21 at the address of the addressable space and the recovery file in the secondary partition 22 through the second interface 33. In an alternative embodiment, the recovery file creator 36 is implemented in the form of one of software and firmware.

On the other hand, in response to a recover command from the central processing unit of the host terminal 1, based on a recovery time (such as, 10 minutes ago, 30 minutes ago, 1 day before, 10 days before, etc.) associated with the recover command, the command interpreter 35 enables the processor 31 to retrieve the recovery files from the secondary partition 22 through the second interface 32. In particular, the write time in each of the recovery files retrieved by the processor 31 is not earlier than the recovery time. Furthermore, based on the contents of the recovery files retrieved by the processor 31, the processor 31 is further enabled by the command interpreter 35 to restore the primary partition 21 to the starting data initially found therein during the recovery time. In particular, the processor 31 restores the primary partition 21 in a chronological order of the write times in the retrieved recovery files starting from one of the retrieved recovery files having a latest write time.

It is noted that, once the hard disk 2 is partitioned, prior to the generation of the write or recover command, the central processing unit of the host terminal 1 generates a capacity inquiry command. The processor 31, in response to the capacity inquiry command received through the first interface 32, reports the total storage capacity of the hard disk 2 as being equal to that of the primary partition 21. As such, the secondary partition 22 of the hard disk 2 is virtually nonexistent with respect to and is therefore not accessible to the host terminal 1. Furthermore, the access control module 3 is likewise responsive to a read command from the central processing unit of the host terminal 1. In response to the read command, the processor 31 retrieves read data at a read address associated with the read command, and sends the read data to the host terminal 1 through the first interface 32.

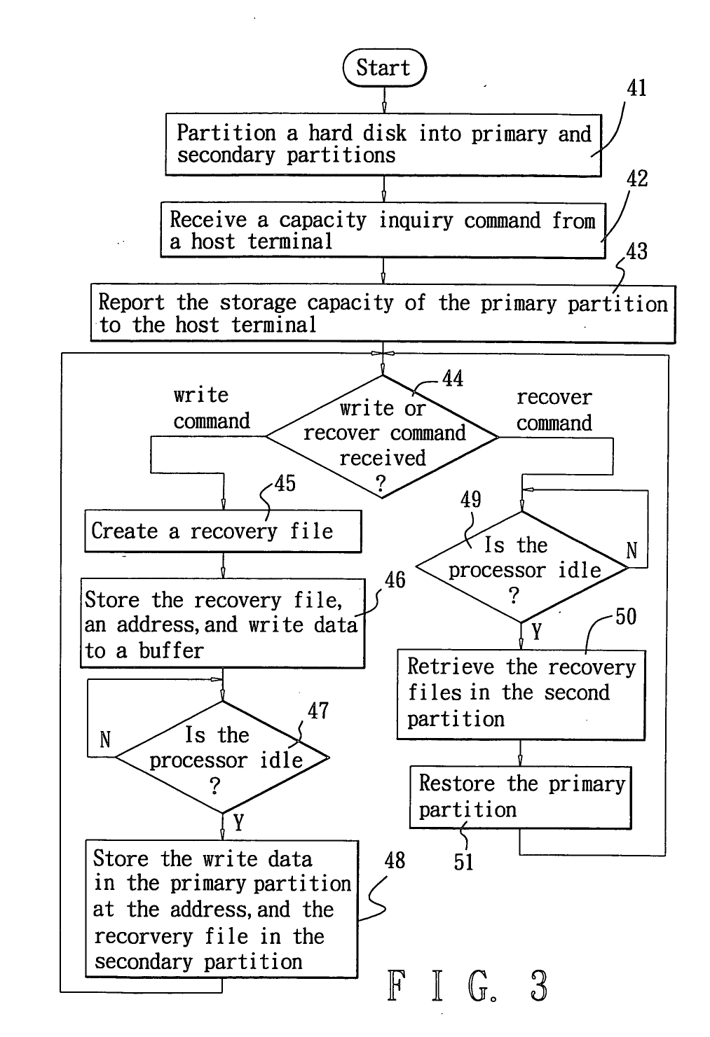

The preferred embodiment of the access control method for the hard disk 2 according to this invention includes the steps shown in FIG. 3.

In step 41, the hard disk 2 is partitioned into the primary and secondary partitions 21, 22 such that the primary partition 21 has the storage capacity (N) and the secondary has the storage capacity (O). Subsequently, in step 42, the processor 31 receives the capacity inquiry command from the central processing unit of the host terminal 1. In response to the capacity inquiry command, in step 43, the processor 31 reports the total storage capacity of the hard disk 2 as being equal to that of the primary partition 21. Then, in step 44, the processor 31 waits for a write or recover command from the central processing unit of the host terminal 1. If a write command was received, the flow proceeds to step 45. On the other hand, if a recover command however was received, the flow proceeds to step 49.

In response to the write command, in step 45, the recovery file creator 36 creates the recovery file. Subsequently, in step 46, the processor 31 stores the address of the addressable space, the write data and the recovery file in the buffer 34. In step 47, it is determined if the processor 31 is idle. When idle, in step 48, the processor 31 is enabled to store the write data in the primary partition 21 at the address of the addressable space, and the recovery file in the secondary partition 22. Thereafter, the flow goes back to step 44.

In response to the recover command, in step 49, it is determined if the processor 31 is idle. When idle, in step 50, the processor 31 is enabled to retrieve the recovery files. Subsequently, in step 51, the processor 31 restores the primary partition 21 back to the starting data based on the contents of the recovery files retrieved thereby. Thereafter, the flow goes back to step 44.

It has thus been shown that the access control method and module 3 for a hard disk 2 according to the present invention partitions the hard disk 2 into the primary and secondary partitions 21, 22 such that, in response to a write command, recovery files, which can be used to restore the primary partition 21 to a previous state, are automatically created and stored in the secondary partition 22 without requiring any action from the user. As such, restoration of the hard disk 2 to a latest workable state can be ensured.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. An access control method for a hard disk, comprising the steps of:
(A) partitioning the hard disk into primary and secondary partitions;
(B) in response to a write command from a host terminal for storing write data in an addressable space found in the primary partition of the hard disk,
(i) creating a recovery file that includes a write time, an address of the addressable space, and recover information including a starting data found in the addressable space of the hard disk during the write time, and
(ii) storing the write data in the primary partition at the address of the addressable space, and the recovery file in the secondary partition; and
(C) in response to a recover command from the host terminal,
(a) retrieving the recovery files from the secondary partition, the write time in each of the retrieved recovery files being not earlier than a recovery time associated with the recover command, and
(b) based on the contents of the recovery files retrieved in sub-step (a), restoring the primary partition to the starting data initially found therein during the recovery time.

2. The method of claim 1, wherein, in sub-step (ii), the address of the addressable space, the write data and the recovery file are stored in a buffer prior to storage in the hard disk.

3. The method of claim 1, wherein the recover information further includes the write data.

4. The method of claim 1, wherein, in sub-step (b), restoring of the primary partition is performed in a chronological order of the write times in the retrieved recovery files starting from one of the retrieved recovery files having a latest write time.

5. The method of claim 1, further comprising the step of reporting a total storage capacity of the hard disk as being equal to that of the primary partition in response to a capacity inquiry command from the host terminal.

6. An access control module for a hard disk that is partitioned into primary and secondary partitions, said access control module being responsive to write and recover commands from a host terminal, and comprising:
a processor;
a first interface adapted to connect said processor to the host terminal;
a second interface adapted to connect said processor to the hard disk;
a command interpreter coupled to said first interface for interpreting the write and recover commands; and
a recovery file creator coupled to said processor and said command interpreter;
wherein, in response to the write command for storing write data in an addressable space found in the primary partition of the hard disk, said command interpreter enables said recovery file creator to create a recovery file that includes a write time, an address of the addressable space, and recover information including a starting data found in the addressable space of the hard disk during the write time, and further enables said processor to store the write data in the primary partition at the address of the addressable space, and the recovery file in the secondary partition; and
wherein, in response to the recover command from the host terminal, said command interpreter enables said processor
to retrieve the recovery files from the secondary partition, the write time in each of the retrieved recovery files being not earlier than a recovery time associated with the recover command, and
based on the contents of the recovery files retrieved by said processor, to restore the primary partition to the starting data initially found therein during the recovery time.

7. The access control module of claim 6, further comprising a buffer coupled to said processor, said processor storing the address of the addressable space, the write data and the recovery file in said buffer prior to storage in the hard disk.

8. The access control module of claim 6, wherein the recover information further includes the write data.

9. The access control module of claim 6, wherein said processor restores the primary partition in a chronological order of the write times in the retrieved recovery files starting from one of the retrieved recovery files having a latest write time.
